(19) United States
(12) Patent Application Publication
(10) Pub. No.: US 2009/0052690 A1
(43) Pub. Date: Feb. 26, 2009

(54) Method for Stabilizing an Adaptive Algorithm and Device for Carring Out Said Method

(76) Inventor: Harry Bachmann, Stafa (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/577,121

(22) PCT Filed: Oct. 7, 2005
(86) PCT No.: PCT/CH05/00589

§ 371 Date: Nov. 6, 2008

(30) Foreign Application Priority Data
Oct. 12, 2004 (CH) 1691/04

(51) Int. Cl. H04B 15/00

(52) U.S. Cl. 381/94.1

(57) ABSTRACT

A method of estimating an unknown transfer function (H) which comprises an input signal (x) and an actual output signal (y), wherein an estimated output signal (ŷ) is generated in an adaptive process (3) using the input signal (x). An error signal (ε) is generated from the actual output signal (y) and the estimated output signal (ŷ) and the error signal (ε) is used to improve the adaptive process (3), whereby at least one of the following signal paths is interrupted or opened depending on at least one condition: a signal path carrying the error signal (ε), a signal path carrying the input signal (x), or a signal path carrying the estimated output signal (ŷ). The method allows substantially stabilizing adaptive processes or algorithms. The disclosed method and device for carrying out the method are useful for active noise reduction in a room.

The present invention is related to a method for stabilizing an adaptive algorithm according to the preamble of claim 1, a use of the method, a device for carrying out the method as well as a use of the device.

Sources of noise are increasingly perceived as environmental pollution and are regarded as reduction of life quality. Because sources of noise often cannot be avoided, methods to reduce noises have already been proposed, which are based on the principle of wave cancelling.

The principle of active noise cancelling (ANC) is based on the cancelling of sound waves by interference. These interferences are generated by one or several electro-acoustic converters, for example by loudspeakers. The signal emitted by the electro-acoustic converters is calculated on the basis of a suitable algorithm and is corrected on a regular basis. As basis for the calculation of the signal emitted by the electro-acoustic converters, information is used that is provided by one or several sensors. This is, on the one side, information on the composition of the signal to be minimized. Thereto, a microphone, for example, can be used that records the sound to be minimized. On the other side, also information is necessary on the remaining residual signal. Microphones can also be used thereto.

The basic principle implemented for active noise reduction has been described by Dr. Paul Lueg in a patent specification going back to the year 1935 having a publication no. AT-141 998 B. This printed publication discloses how noise can be cancelled in a tube by generating a signal having opposite phase.

Further developments lead to a number of specific algorithms, as for example the LMS (Least Mean Square) and related algorithms, as for example the FxLMS and the NLMS.

An algorithm for active noise cancelling needs information of at least one sensor (for example a microphone), which determines the residual error—in the following also called error signal. Dependent on implementation and implemented algorithm, a further sensor is provided that provides information on the composition of the signal to be minimized. Furthermore, adaptive noise reduction system needs one or several actuators (for example in the manner of a loudspeaker) in order to output the correcting signal. The information of the sensors must be converted in a corresponding format by an analog-to-digital converter. The signal is reconverted by a digital-to-analog converter after processing by the algorithm, and transmitted to the actuators. These converters are limited regarding its resolution as well as regarding its dynamic.

Many algorithms, in particular the known-gradient methods, show several instabilities for uncorrelated input signals. Together with the limitations of the converters, this can lead to an uncontrolled behavior of the algorithm for small input signals. This can result in low frequency noise or also in a general instable behavior of the overall system.

The present invention has therefore the object to provide a method for stabilizing an adaptive algorithm that does not have the afore-mentioned drawbacks.

This object is resolved by the elements given in the characterizing part of claim 1. Advantageous embodiments, a use of the method, a device for carrying out the method as well as a use of the device are given in further claims.

A method for stabilizing an adaptive algorithm, with the aid of which an unknown transfer function is estimated, that has an input signal and an actual output signal, are disclosed. The method consists in that an estimated output signal is generated with the aid of an adaptive process by using the input signal, in that an error signal is generated from the actual output signal and the estimated output signal, and in that the adaptive process is improved on the basis of the error signal. According to the present invention, at least one of the following signal paths is/are interrupted or opened, respectively, in dependence on at least one condition:
a signal path carrying an error signal;
a signal path carrying an input signal;
a signal path carrying the estimated output signal.

Therewith, a method is created for the first time that is in particular suitable for stabilizing an adaptive algorithm. Thereby, non process-able signals can be eliminated beforehand by the adaptive process according to the present invention. As a result thereof, the system, in its whole, will be more stable and more robust.

A further embodiment of the present invention consists in that a given signal level or a given medium signal power falls below or exceeds, respectively, one of the following signals:
input signal;
estimated output signal;
error signal.

There from it results that the method according to the present invention controls itself and automatically adapts its structure to the current signal shape and signal strength.

In a still further embodiment of the present invention, it is provided that the condition for amending a signal path depends on the signal carried in this signal path.

Finally, it is provided for, in another embodiment, that several signal paths are interrupted or opened, respectively, at the same time.

Even though the method according to the present invention is particularly suitable for the active noise cancelling, other applications are not at all excluded. In contrary: The method according to the present invention is excellently suitable for all adaptive systems for the improvement of the stability and the robustness.

Furthermore, a device is an subject of the present invention, which device comprises the following features:
an adaptive processing unit for the determination of an estimated output signal, an input signal is being fed to the processing unit,
means for determining an error signal from an actual output signal and the estimated output signal, the error signal being fed to the adaptive processing unit, and
a switching unit in at least one of the following signal paths:
   a signal path carrying the error signal;
   a signal path carrying the input signal;
   a signal path carrying the estimated output signal.

A further embodiment comprises means for determining a level or a mean power of a signal, these means being operationally connected to at least one switching unit.

For a still further embodiment of the present invention, the means for determining a level or a mean power of a signal are operationally connected to the switching unit in the same signal path.

For a further embodiment of the present invention, several switching units are activate-able at the same time.

For a further embodiment of the present invention the switching unit comprises an adjustable characteristic switching curve.

Finally, for a further embodiment of the present invention, the switching units are operationally connected.

The present invention will be further described with the help of exemplified embodiments by referring to drawings. It is shown in:

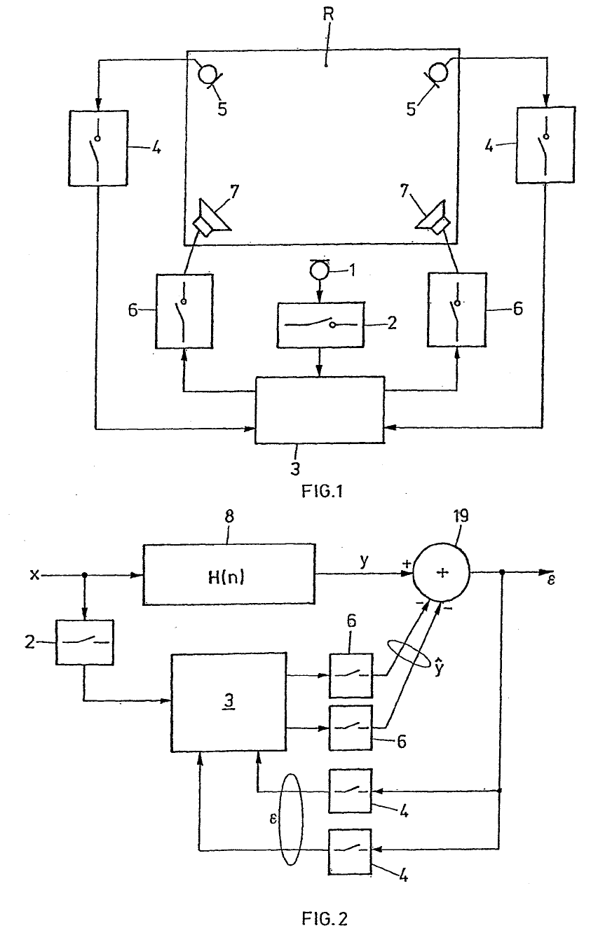

FIG. 1 an embodiment of a device according to the present invention, in schematic representation,

FIG. 2 a simplified block diagram of the embodiment depicted in FIG. 1, also in schematic representation,

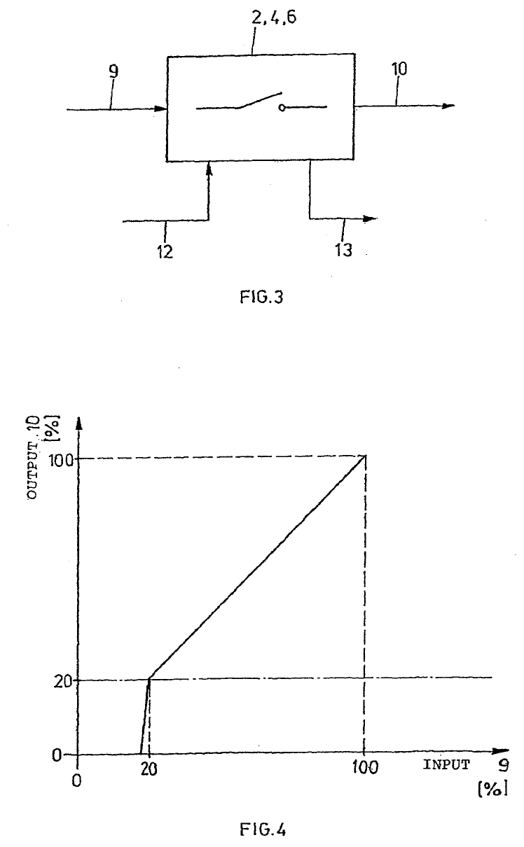

FIG. 3 a simplified block diagram of a switching unit used in FIGS. 1 and 2, and

FIG. 4 a signal course for the illustration of a possible manner of functioning of a switching unit according to FIG. 3.

FIG. 1 shows an embodiment of a device according to the present invention for reducing of interference noise. It is a so called adaptive noise cancelling system (ANC), with the aid of which a interference noise is eliminated or at least reduced in a room R by implementing of the principal of signal elimination.

Central unit of such an adaptive noise cancelling system is an adaptive processing unit 3, which is operationally connected to an external microphone unit 1, the addition “external” indicating that the microphone unit is arranged outside the room R. Therewith, an interference noise source generally being outside the room R can be better recorded. Furthermore, two internal microphone units 5 and two loudspeaker units 7 are provided in the room R, which units are all operationally connected to the adaptive processing unit 3. As can be seen from FIG. 1, a switching unit 2, 4, 6 is provided between one of the microphone units 1, 5 and the adaptive processing unit 3 or between one of the loudspeaker units 7 and the adaptive processing unit 3, respectively. The switching unit 2, 4, 6 makes it possible to interrupt the respective signal path.

In the adaptive processing unit 3, a cancelling signal is fed into the room R via the loudspeakers 7 on the basis of the signal recorded by the microphone unit 1 in such a manner that a interference signal reaching the room R via the walls or windows is cancelled or reduced, respectively, by signal elimination or cancelling, respectively. In order that this can be reached under changing conditions with success, an error signal is recorded with the aid of the microphone unit 5 and fed to the adaptive processing unit 3 such that the calculations of the reduction signal can be improved in the adaptive processing unit 3, and, in the following, an optimum signal cancelling or signal reduction, respectively, can be obtained.

It is expressly pointed out that any number of microphone units 1, 5 and loudspeaker units 7 are conceivable without leaving the principle of the present invention. In addition, other converting units than the microphone units 1, 5 and/or the loudspeaker units 7 are conceivable.

FIG. 2 shows a block diagram of a simplified equivalent circuit of the embodiment of the present invention according to FIG. 1. According to the present invention, the signal path can be interrupted, which is contrived by the switching unit 2, 4, 6. A switching unit 2, 4, 6 denotes, in this case, a switch that is controlled by the value of a parameter. The value of the parameter corresponds, for example, to the average input power or the input level. The switching unit 2, which is connected in between the microphone unit 1 and the adaptive processing unit 3, is used for interrupting the signal path towards the adaptive processing unit 3 as soon as, for example, the interference noise recorded by the microphone unit 1 falls below a given signal level. The adaptive processing unit 3 does not receive any interference noise anymore as a result of the signal path interruption. As a result thereof, the adaptive processing unit 3 does also not provide a reduction signal anymore to the loudspeaker unit 7. This configuration makes sense, for example, if an interference noise below certain loudness must not actively be minimized because the walls or windows already sufficiently reduced the interference noise. In addition, and as further embodiment of the present invention, the signal path from a signal generator generating the reduction signal to the loudspeaker unit 7 can be controlled by the switching unit 6, which is connected in between the adaptive processing unit 3 and the loudspeaker unit 7. Thus, no signal will be fed to the loudspeaker units 7 as soon as the switching unit 6 interrupts the signal path to the loudspeaker unit 7. In this way, possible background noise, which is generated by the loudspeaker unit 7 itself, is suppressed. Also this strongly improves the stability of the overall system because this background noise is otherwise recorded by the sensors—i.e. the microphone units 5 recording the residual noise. The additional switching unit 4, which can also be activated in dependence on the interference noise, can interrupt the signal path carrying the error signal. This causes that the adaptive processing unit 3 does not receive an error signal of the corresponding microphone unit 5; therewith, the adaptive processing unit 3 assumes that the system is optimally adapted to the momentary situation and that it is not necessary to optimize further.

The implementation of one of the above-mentioned embodiments with a switching unit as well as a combination of two or more of the above-mentioned embodiments results in an essential improvement of stability of the overall system, because input signals being soft and therewith difficult to process, are eliminated. Therewith, possible insufficiencies of the analog-to-digital and digital-to-analog converters necessary for digital systems or other components lose their influence.

A limit can also be defined for the residual noise in the room R; in case of falling below this limit, the error signal ε is switched off, i.e. the signal path from the internal microphone unit 5 to the adaptive processing unit 3 is interrupted. This will be interpreted by the adaptive processing unit 3 such that no error signal ε is present. Also from this, it follows that low signals, and therefore signals that are difficult to process, are eliminated from the calculations. Depending on the mute switching of the error signal ε, the external microphone unit 1, which is used to record interference noise, as well as one or several loudspeaker units 7 can be controlled. Such configurations make, for example, sense when the adaptive processing unit 3 works only then, when a given threshold is exceeded in the room R.

As already pointed out, a switching unit 2, 4, 6 functions like a switch having a state that depends on the input value. It is not important for the functioning of a switching unit 2, 4, 6, whether the level, the average power or another value is obtained of the input signal.

The basic functioning of a switching unit 2, 4, 6 will be further explained in the following on the basis of FIGS. 3 and 4.

FIG. 3 shows a switching unit 2, 4, 6, to which an input signal 9 is fed. In the switching unit 2, 4, 6, an output signal 10 is generated that results, for example, from the input/output course according to FIG. 4. Thereby, any characteristic curve can be used, in particular following the functioning of a so called AGC-(Automatic Gain Control) unit is conceivable in order that the signal can also be amplified or damped. The graphic depicted in FIG. 4 shows, on the horizontal axis, the level of the input signal 9 and, on the vertical axis, the level of the corresponding output signal 10. From the graph shown, the following can be deducted: As soon as the input signal 9 of the switching unit 2, 4, 6 falls below a given threshold, the output signal 10 of the switching unit 2, 4, 6 will be switched to zero, i.e. the signal path via the switching unit 2, 4, 6 is interrupted. Therefore, the output signal 10 shows no value if the input signal 9 lies below the given threshold. On the other side, the output signal 10 corresponds to the input signal 9 if the input signal 9 exceeds the given threshold.

A further embodiment—as is also envisioned in FIG. 4—consists in that the switching unit 2, 4, 6 comprises a control input 12. Via this control input 12, the switching unit 2,4,6 can be controlled. A control signal is generated, for example, in the adaptive processing unit 3 or in one of the other switching units 2, 4, 6.

A still further embodiment of the present invention consists in that the switching unit 2, 4, 6 comprises a control output 13, via which also other switching units 2, 4, 6 can be controlled. It is also conceivable that the states of the switching unit 2, 4, 6 are transmitted via the control output 13 to the adaptive processing unit 3 or another calculating unit for further processing.

The control output 13 and the control input 12 can also be used as inverted signals. In this manner, a switching unit 2, 4, 6, for example, at that time (i.e. the signal path via the switching unit 2, 4, 6 is not interrupted), when the signal path via another switching unit 2, 4, 6 is interrupted. Thereby, it is provided, for example, that the time can be adjusted that it takes until the switching unit 2, 4, 6 interrupts the signal path after exceeding the given threshold. Similarly, the time can be adjusted, which is needed by the switching unit 2, 4, 6 to reopen the signal path after falling below the given threshold. This has the advantage that the signal path is not interrupted or opened, respectively, by the switching unit 2, 4, 6 before and after each zero crossing. Therewith, further instabilities of the overall system can be prevented by the invention.

1. Method for stabilizing an adaptive algorithm, with the aid of which an unknown transfer function (H) is estimated that has an input signal (x) and an actual output signal (y), the method comprising:
generating an estimated output signal (ŷ) by using the input signal (x) with the aid of an adaptive process (3),
generating an error signal (ε) from the actual output signal (y) and the estimated output signal (ŷ), and
improving the adaptive process (3) on the basis of the error signal (ε),
wherein at least one of the following signal paths is interrupted in dependence on at least one condition:
a signal path carrying the error signal (ε);
a signal path carrying the input signal (x);
a signal path carrying the estimated output signal (ŷ).

2. Method according to claim 1, wherein the at least one condition includes that a given signal level or a given mean signal power falls below of one of the following signals:
input signal (x);
estimated output signal (ŷ);
error signal (ε).

3. Method for stabilizing an adaptive algorithm, with the aid of which an unknown transfer function (H) is estimated that has an input signal (x) and an actual output signal (y), the method comprising:
generating an estimated output signal (ŷ) by using the input signal (x) with the aid of an adaptive process (3),
generating an error signal (ε) from the actual output signal (y) and the estimated output signal (ŷ), and
improving the adaptive process (3) on the basis of the error signal (ε),
wherein at least one of the following signal paths is opened in dependence on at least one condition:
a signal path carrying the error signal (ε);
a signal path carrying the input signal (x);
a signal path carrying the estimated output signal (ŷ).

4. Method according to claim 3, wherein the at least one condition includes that a given signal level or a given mean signal power exceeds one of the following signals:
input signal (x);
estimated output signal (ŷ);
error signal (ε).

5. Method according to claim 3, wherein the condition for amending a signal path depends on the signal (x, ε, ŷ) carried in this signal path.

6. Method according to claim 3, including opening several signal paths at the same time.

7. Method according to claim 3, including using the method for the active noise reduction in a room (R).

8. Device for carrying out a method for stabilizing an adaptive algorithm, with the aid of which an unknown transfer function (H) is estimated that has an input signal (x) and an actual output signal (y), the device comprising:
an adaptive processing unit (3) for the determination of an estimated output signal (ŷ), an input signal (x) being fed to the adaptive processing unit (3),
means (19) for determining an error signal (E from the actual output signal (y) and the estimated output signal (ŷ), the error signal ε being fed to the adaptive processing unit (3), and
a switching unit (2, 4, 6) in at least one of the following signal paths:
a signal path carrying the error signal (ε);
a signal path carrying the input signal (x);
a signal path carrying the estimated output signal (ŷ).

9. Device according to claim 8, further comprising means for determining a level or a mean power of a signal (x, ε, ŷ), the means being operatively connected to the at least one switching unit (2, 4, 6).

10. Device according to claim 9, wherein the means for determining a level or a mean power of a signal (x, ε, ŷ) in a signal path are operatively connected to the switching unit (2, 4, 6) in the same signal path.

11. Device according to claim 8, including several switching units, the several switching units (2, 4, 6) being activatable at the same time.

12. Device according to claim 8, wherein the at least one unit (2, 4, 6) has an adjustable switching characteristic.

13. Device according to claim 8, including several switching units, wherein the switching units (2, 4, 6) are operationally interconnected.

14. A method for the active noise reduction in a room (R), comprising:
providing a device for carrying out a method for stabilizing an adaptive algorithm, with the aid of which an unknown transfer function (H) is estimated that has an input signal (x) and an actual output signal (y), the device comprising:
an adaptive processing unit (3) for the determination of an estimated output signal (ŷ), an input signal (x) being fed to the adaptive processing unit (3),
means (19) for determining an error signal (E) from the actual output signal (y) and the estimated output signal (ŷ), the error signal ( ) being fed to the adaptive processing unit (3), and
a switching unit (2, 4, 6) in at least one of the following signal paths:
a signal path carrying the error signal (ε);
a signal path carrying the input signal (x);
a signal path carrying the estimated output signal (ŷ).
using the device for the active noise reduction in a room (R).

15. Method according to claim 1, wherein the condition for amending a signal path depends on the signal (x, ε, ŷ) carried in this signal path.

16. Method according to claim 1, including interrupting several signal paths at the same time.

17. Method according to claim 1, including using the method for the active noise reduction in a room (R).
